(19) United States
(12) Patent Application Publication
(10) Pub. No.: US 2017/0051931 A1
(43) Pub. Date: Feb. 23, 2017

(54) Method for Scheduling Heating/ Cooling for a Climate Controlled Area

(71) Applicants: Joseph A Logan, Big Bear Lake, CA (US); Conrad P Lindberg, Fallbrook, CA (US)

(72) Inventors: Joseph A Logan, Big Bear Lake, CA (US); Conrad P Lindberg, Fallbrook, CA (US)

(21) Appl. No.: 14/828,334

(22) Filed: Aug. 17, 2015

(51) Int. Cl. F24F 11/00; G05B 15/02; F24F 11/02

(52) U.S. Cl. CPC F24F 11/006; F24F 11/001; F24F 11/0076; F24F 11/022; G05B 15/02; F24F 2011/0056; F24F 2011/0063; F24F 2011/0068; F24F 2011/0073

(57) ABSTRACT

A method of controlling a heating, ventilating, and air conditioning system on a customized schedule utilizes a master controller and a plurality of satellite vents. Each of the plurality of satellite vents is associated with a vent address which can be addressed through the master controller. A plurality of actuation commands, wherein each of the actuation commands contains a vent position which is transmitted to a specific vent of the plurality of satellite vents. The master controller utilizes a wireless transmitter to broadcast the actuation commands. Next, each of the plurality of satellite vents periodically listen for the actuation commands. A specific command of the actuation commands is executed if the vent address of the actuation command matches the physical address of the specific vent and a current time matches a set time of the specific command.

The current application is a non-provisional application and claims a priority to the U.S. provisional patent application Ser. No. 62/037,709 filed on Aug. 15, 2014. The current application is filed on Aug. 17, 2015 while Aug. 15, 2015 was on a weekend.

### FIELD OF THE INVENTION

The present invention relates generally to a method of controlling the heating/cooling system of a climate controlled area. In particular, the present invention allows the user to schedule the vent position such that the overall air flow from the vent can be controlled.

### BACKGROUND OF THE INVENTION

Currently, residential homes and businesses with a conventional heating, ventilating, and air conditioning system utilize adjustable vents to control the air flow into a climate controlled area. Even though these vents have multiple benefits such as, low maintenance and longevity, they do have certain drawbacks too.

In most instances, when a system with multiple vents is used, all of the vents are either open or closed simultaneously. More specifically, the system lacks the ability to individually control the vents. If the need to control the vents individually occurs, the user needs to manually open or close the vent. The process of manually closing or opening a vent can be time consuming and also impractical at times.

The waste of energy is another disadvantage of having multiple vents open simultaneously. As an example, we shall consider a house with multiple levels. In most instances, a majority of the occupants of the household utilize a limited portion of the entire house. Therefore, if the vents in the unused areas of the house are open, a portion of the heating or cooling energy is wasted. Therefore, the need for a method of controlling the vents in unused areas is clearly evident.

Similar to controlling the vents in areas used less frequently, controlling the vents in the most frequently used areas is equally important. If these widely used areas are not at a preferred temperature when required, the user may have to experience unpleasant situations. In order to address the issue, a system that has the ability to control the temperature to a preferred temperature, at a preferred time is clearly needed.

The objective of the present invention is to address the aforementioned issues. In particular, the present invention introduces a method of controlling a vent on a personalized schedule. As a result, the unused rooms can be configured not to be cooled or heated. On the other hand, another room of the house can be configured to be heated or cooled at a preferred time such that the room is at the preferred temperature when the user enters room. By utilizing the method introduced by the present invention, the user is guaranteed to save energy. Moreover, the user is guaranteed to experience preferred cooling or heating temperatures due to the initial scheduling of the vents. Since the present invention controls each of the vents through a wireless connection, the present invention also eliminates the need to manually control each vent.

### BRIEF DESCRIPTION OF THE DRAWINGS

FIG. 1 is a flowchart illustrating the basic overall process of the present invention.

FIG. 2 is a flowchart illustrating the basic overall process of using the master controller.

FIG. 3 is a flowchart illustrating the basic overall process of using an external computing device.

FIG. 4 is a flowchart illustrating the basic overall process of tracking time.

FIG. 5 is a flowchart illustrating the basic overall process of activating and deactivating the wireless receiver of the specific vent.

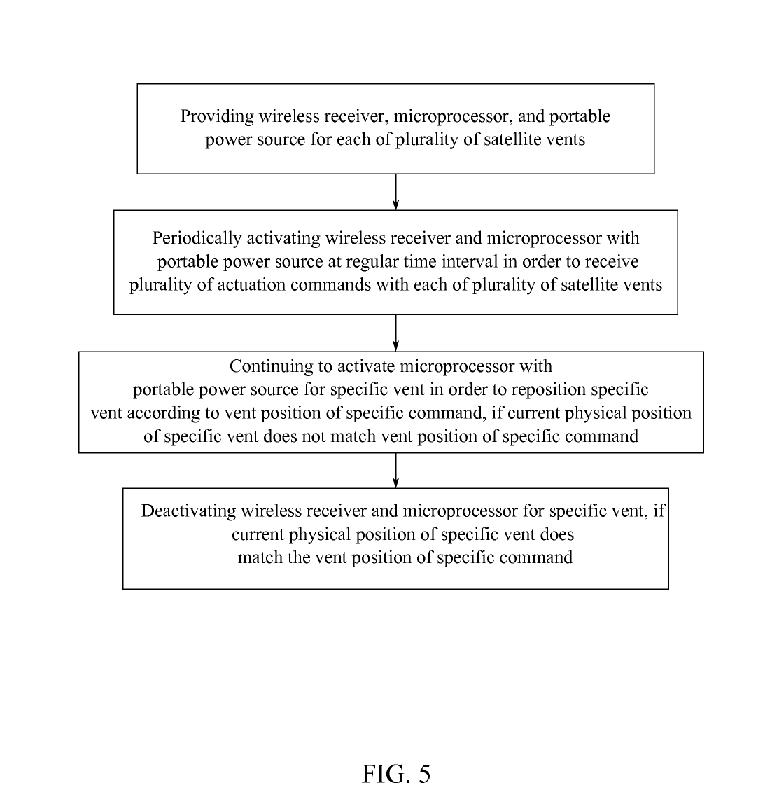

FIG. 6 is a flowchart illustrating the basic overall process of controlling the louver system.

FIG. 7 is a flowchart illustrating the basic overall process of utilizing an indicator light in each of the plurality of satellite vents.

### DETAIL DESCRIPTIONS OF THE INVENTION

All illustrations of the drawings are for the purpose of describing selected versions of the present invention and are not intended to limit the scope of the present invention.

The present invention introduces a method for controlling a set of vents within a house or other comparable location. More specifically, the present invention allows a user to individually control a specific vent such that the heating or cooling of the room the specific vent is positioned in can be conveniently adjusted. Therefore, the method introduced in the present invention can be used to save heating/cooling energy and also to obtain preferred temperature conditions.

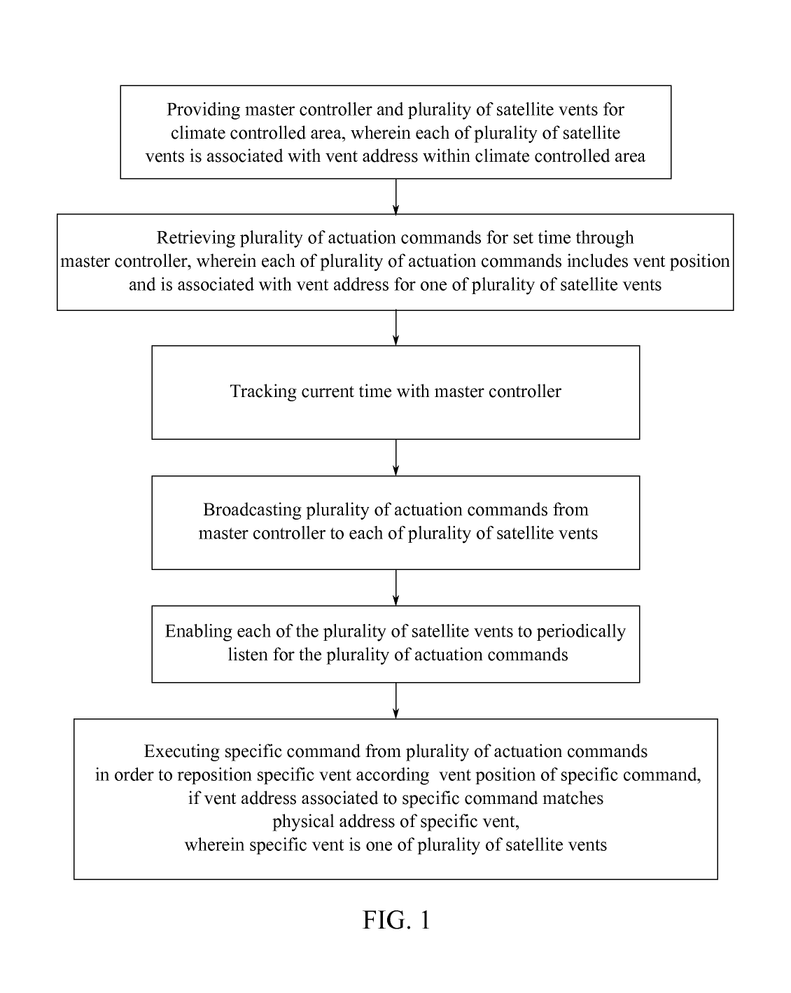

As illustrated in FIG. 1, a master controller and a plurality of satellite vents for a climate controlled area are initially provided to execute the method of the present invention. Each of the plurality of satellite vents is associated with a vent address within the climate controlled area. The vent address is used to identify a specific vent from the plurality of satellite vents. As an example, a first vent from the plurality of satellite vents in a bedroom has a different vent address from a second vent from the plurality of satellite vents in a kitchen. In order to control each of the plurality of satellite vents individually, the present invention retrieves a plurality of actuation commands for a set time through the master controller. The plurality of actuation commands is utilized to send the user commands to the plurality of satellite vents. In order to do so, each of the plurality of actuation commands includes a vent position, and is associated with the vent address for one of the plurality of satellite vents. The set time determines the time period in which the plurality of satellite vents remain open, closed, or partially open. On the other hand, the vent position determines if the plurality of satellite vents is open, closed, or partially open for the time designated by the set time. In order to control the plurality of satellite vents remotely, the plurality of actuation commands is broadcasted from the master controller to each of the plurality of satellite vents periodically. In the preferred embodiment of the present invention, the actuation commands are broadcasted once every few seconds. The plurality of satellite vents is enabled to periodically listen to the plurality of actuation commands. In the preferred embodiment of the present invention, the plurality of satellite vents listens once every few minutes. As a result, the plurality of satellite vents only spends a limited time with the receiving circuits enabled to receive the actuation commands from the master controller. Since, the plurality of satellite vents is disabled for the majority of the time, the power usage of each of the plurality of satellite vents is limited. The present invention tracks the current time with the master controller. Tracking the current time is especially important to correspond to the set time of the plurality of actuation commands. In the process of controlling the specific vent, the present invention initially executes a specific command from the plurality of actuation commands in order to reposition the specific vent according to the vent position of the specific command. When executing the specific command, the vent address and the set time are taken into consideration. More specifically, the specific command is executed on the specific vent if the vent address associated to the specific command matches a physical address of the specific vent. In other words, the specific vent is controlled according to the schedule set by the specific command.

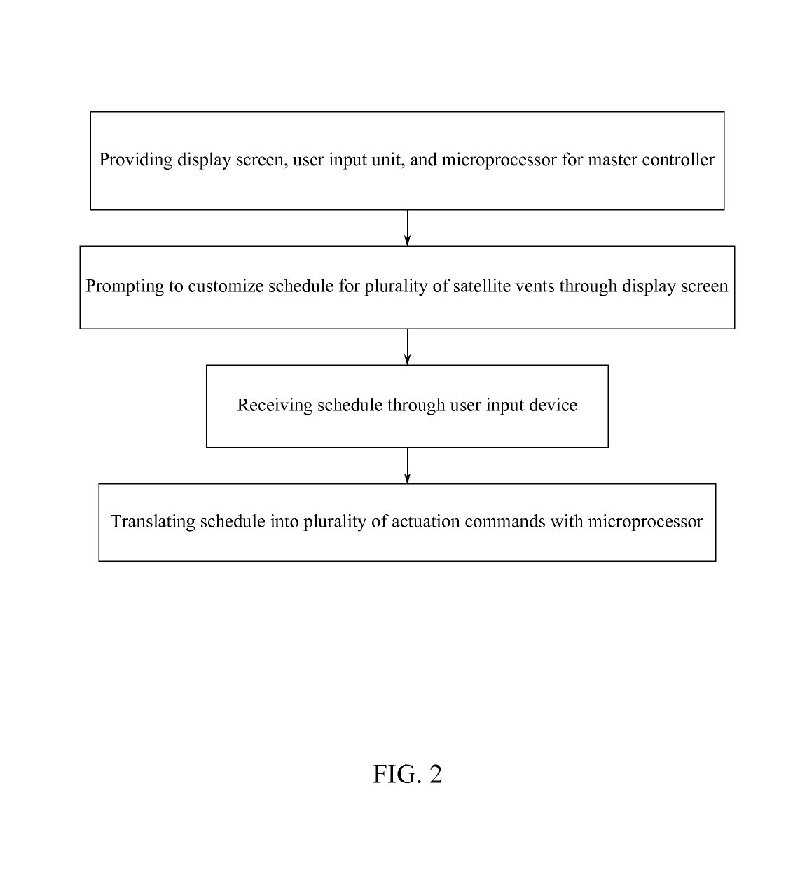

The user utilizes the master controller to schedule each of the plurality of satellite vents. In order to do so, the present invention provides the master controller with a display screen, a user input unit, and a microprocessor. The size and shape of the display screen can vary in different embodiments of the present invention. The user utilizes the display screen in the process of setting a schedule for the plurality of satellite vents. In order to do so, the present invention initially prompts the user to view and customize the schedule for the plurality of satellite vents through the display screen as illustrated in FIG. 2. The schedule preferred by the user is received through the user input unit. In the preferred embodiment of the present invention the user input unit is a plurality of buttons. However, the user input unit can vary in different embodiments of the present invention. When receiving the schedule is complete, the present invention translates the schedule into the plurality of actuation commands with the microprocessor.

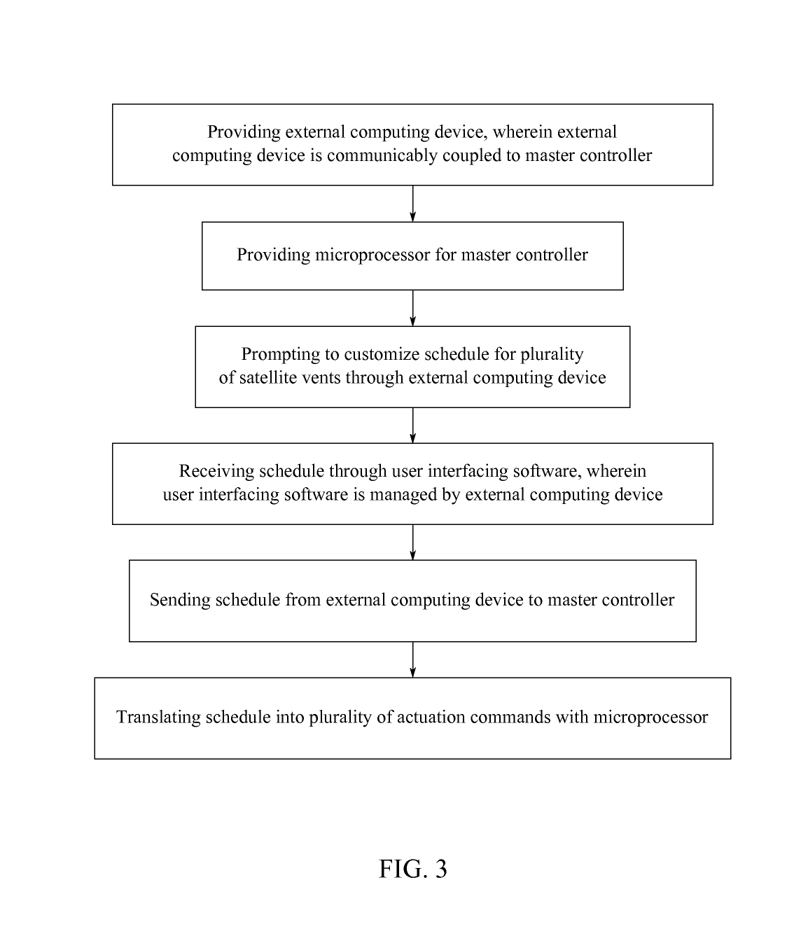

In order to provide user convenience, the master controller is provided with the ability to connect to an external computing device. In particular, the user has the ability to communicably couple the external computing device to the master controller. The external computing device and the master controller can be connected wirelessly or through a hard wired connection. As previously executed through the user input unit, the user is prompted to customize the schedule for the plurality of satellite vents through the external computing device as shown in FIG. 3. When customizing the schedule is complete, the present invention receives the schedule through a user interfacing software. In particular, the user interfacing software is managed by the external computing device. Next, the schedule is sent from the external computing device to the master controller where the schedule is translated into the plurality of actuation commands. The microprocessor is used to translate the schedule into the plurality of actuation commands.

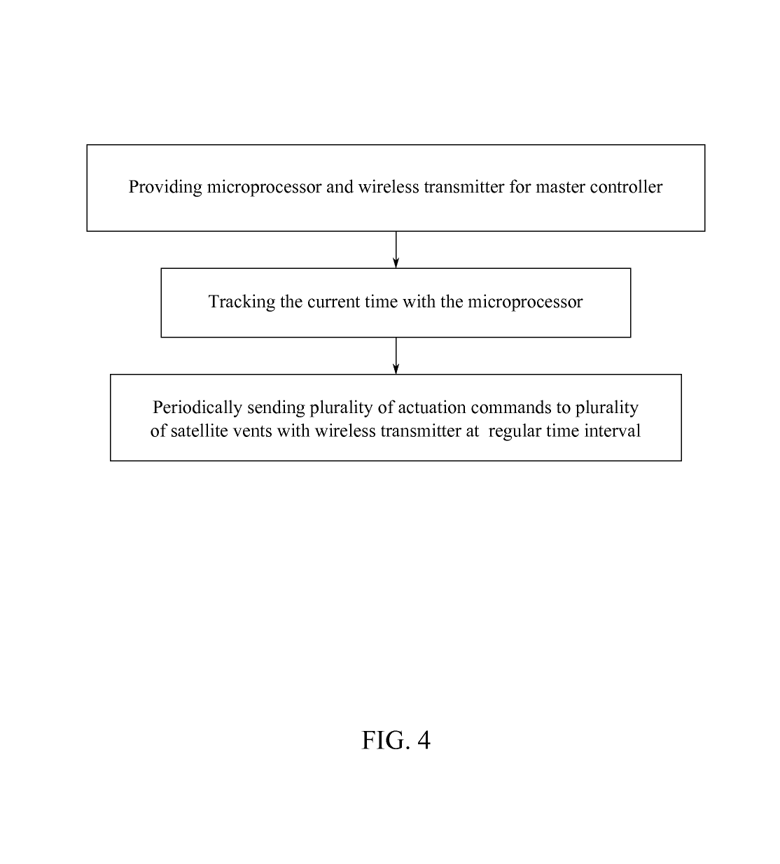

As discussed earlier, the present invention tracks current time. The microprocessor of the master controller can also be utilized to track the current time. Based on the schedule provided by the user and the current time, the present invention periodically sends out a plurality of actuation commands to the plurality of satellite vents at a regular time interval. In order to do so, a wireless transmitter of the master controller is utilized. In the preferred embodiment of the present invention, the regular time interval is set to be two seconds. However, the regular time interval can vary in different embodiments of the present invention. FIG. 4 illustrates the process of tracking time and sending the plurality of actuation commands through wireless transmitter.

Each of the plurality of satellite vents are equipped to receive the actuation commands transmitted by the wireless transmitter. More specifically, a wireless receiver, a microprocessor, and a portable power source is provided for each of the plurality of satellite vents. The portable power source, the microprocessor, and the wireless receiver are electronically connected to each other. As a result, the microprocessor and the wireless receiver are powered through the portable power source. In the preferred embodiment of the present invention, the portable power source is a battery. However, different power sources can be utilized as the portable power source in different embodiments of the present invention. In order to successfully receive the plurality of actuation commands, the portable power source and the microprocessor are periodically activated at a regular time interval. In the preferred embodiment of the present invention, the regular time interval for each of the plurality of satellite vents is two minutes. However, the regular time interval can vary in different embodiments of the present invention. The microprocessor maintains a low power state when the specific vent is not receiving the actuation commands. As a result, the power usage of the portable power source is limited. At the regular time interval, the wireless receiver is enabled and the microprocessor transitions into a normal power state. When the specific vent receives the specific command, the microprocessor is continuously activated in order to reposition the specific vent according to the vent position of the specific command. In doing so, a current physical position of the specific vent is compared with the vent position of the specific command. The repositioning process is completed only if the current physical position does not match the vent position of the specific command. If the current physical position of the specific vent matches with the vent position of the specific command, the wireless receiver and the microprocessor are deactivated for the specific vent. In other words, the microprocessor returns to a low power state.

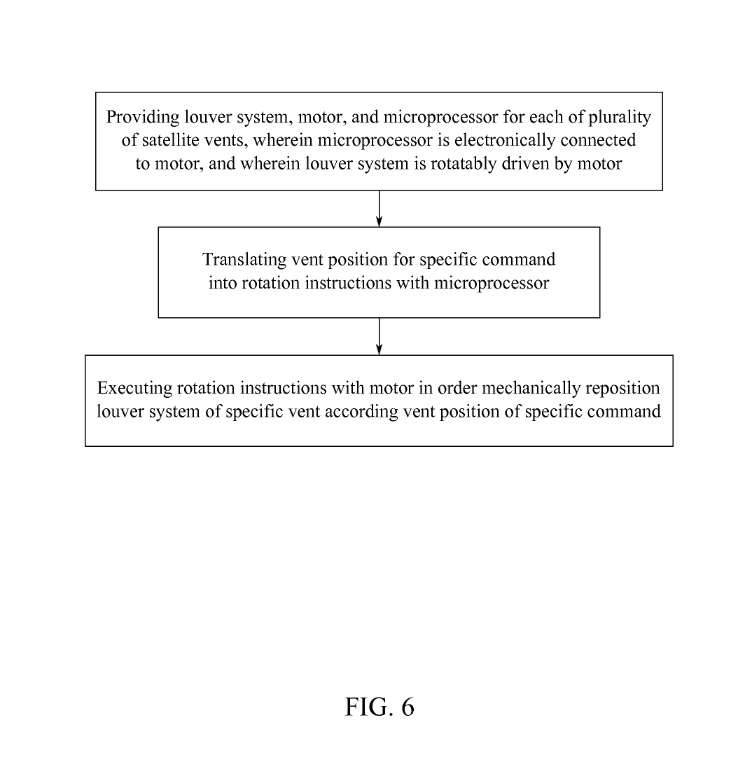

In order to control the air flow from the specific vent, a louver system and a motor is provided for each of the plurality of satellite vents. The vent position for the specific command, which can be open, closed, or partially open, is translated into rotation instructions with the microprocessor. Since the microprocessor of the specific vent is electronically connected to the motor, the rotation instructions are transferred to the motor. Next, as seen in FIG. 6, the rotation instructions are executed with the motor in order to mechanically reposition the louver system of the specific vent according to the vent position of the specific command. In order to do so, the louver system is rotatably driven by the motor. As a result, information regarding the vent position is successfully transferred to the louver system.

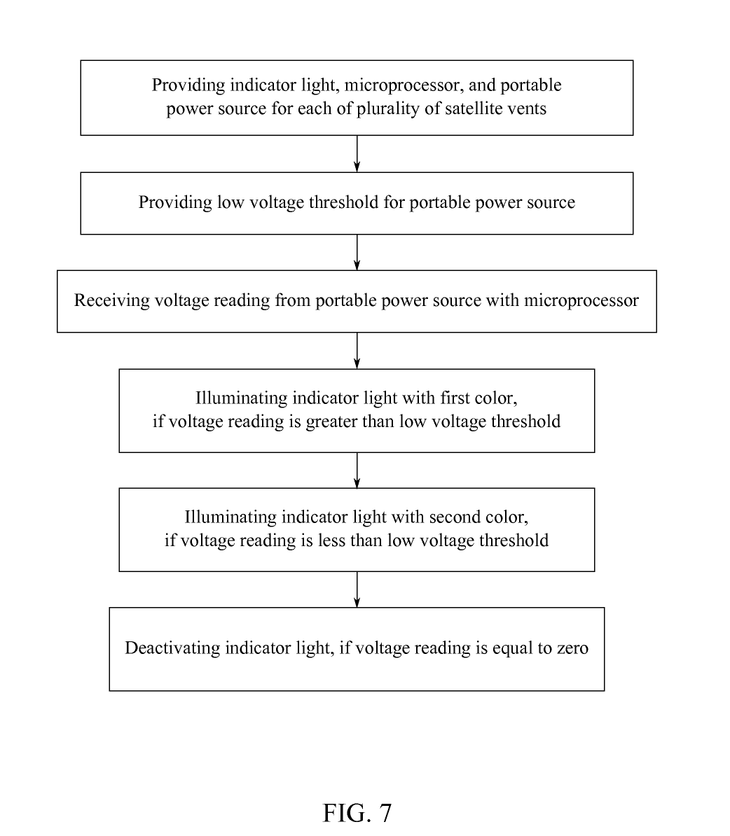

The present invention notifies the user when the portable power source is below recommended values. In order to do so, an indicator light is provided for each of the plurality of satellite vents. Moreover, a low voltage threshold is also provided for the portable power source. The indicator light and the low voltage threshold are utilized simultaneously to determine if the voltage level of the portable power source is below the recommended values. As illustrated in FIG. 7, a voltage reading is initially received from the portable power source through the microprocessor. The received voltage reading is compared with the low voltage threshold. If the voltage reading is greater than the low voltage threshold, a first color of the indicator light is illuminated. On the other hand, a second color is illuminated if the voltage reading is less than the low voltage threshold. The use of the first color and the second color helps the user understand the status of the portable power source. Utilizing a similar voltage comparison method, the indicator light is deactivated if the voltage reading is equal to zero.

When the user intends on using the method introduced by the present invention, the following process flow can be followed. Initially, the user schedules the vent position for each of the plurality of satellite vents. In doing so, the user utilizes the user input unit of the master controller. Next, the microprocessor of the master controller translates the schedule provided by the user to the plurality of actuation commands. Each of the plurality of actuation commands has the set time and the vent position for the specific vent. In the preferred embodiment of the present invention, an 8-bit code is transmitted from the wireless transmitter to the plurality of satellite vents. The first 4-bits of the specific command contains the vent address and for the specific vent. On the other hand, the last 4-bits of the specific command contains the vent position of the specific vent. When the specific command is transmitted, the specific vent receives the specific command through the wireless receiver. Upon receiving the specific command for the set time, information regarding the vent position is transferred to the microprocessor of the specific vent. Subsequently, the microprocessor transfers information from the specific command to the motor such that the louver position can be adjusted accordingly.

In the preferred embodiment, the present invention utilizes only the master controller and the plurality of satellite vents. However, in other embodiments the present invention can utilize motion sensors in each of the plurality of satellite vents. More specifically, the motion sensors can be utilized to control the louver system such that the specific vent opens or closes according to the motion sensor.

Although the invention has been explained in relation to its preferred embodiment, it is to be understood that many other possible modifications and variations can be made without departing from the spirit and scope of the invention as hereinafter claimed.

What is claimed is:

1. A method for controlling a heating, ventilating, and air conditioning (HVAC) system on a customized schedule, the method comprises the steps of:
providing a master controller and a plurality of satellite vents for a climate controlled area, wherein each of the plurality of satellite vents is associated with a vent address within the climate controlled area;
retrieving a plurality of actuation commands for a set time through the master controller, wherein each of the plurality of actuation commands includes a vent position and is associated with the vent address for one of the plurality of satellite vents;
tracking current time with the master controller;
broadcasting the plurality of actuation commands from the master controller to each of the plurality of satellite vents,
if the current time does match the set time;
enabling each of the plurality of satellite vents to periodically listen for the plurality of actuation commands; and
executing a specific command from the plurality of actuation commands in order to reposition a specific vent according the vent position of the specific command,
if the vent address associated to the specific command matches a physical address of the specific vent,
wherein the specific vent is one of the plurality of satellite vents.

2. The method for controlling a heating, ventilating, and air conditioning (HVAC) system on a customized schedule, the method as claimed in claim 1 comprises the steps of:
providing a display screen, a user input unit, and a microprocessor for the master controller;
prompting to customize a schedule for the plurality of satellite vents through the display screen;
receiving the schedule through the user input unit; and
translating the schedule into the plurality of actuation commands with the microprocessor.

3. The method for controlling a heating, ventilating, and air conditioning (HVAC) system on a customized schedule, the method as claimed in claim 1 comprises the steps of:
providing an external computing device, wherein the external computing device is communicably coupled to the master controller;
providing a microprocessor for the master controller;
prompting to customize a schedule for the plurality of satellite vents through the external computing device;
receiving the schedule through a user interfacing software, wherein the user interfacing software is managed by the external computing device;
sending the schedule from the external computing device to the master controller; and
translating the schedule into the plurality of actuation commands with the microprocessor.

4. The method for controlling a heating, ventilating, and air conditioning (HVAC) system on a customized schedule, the method as claimed in claim 1 comprises the step of:
providing a microprocessor and a wireless transmitter for the master controller;
tracking the current time with the microprocessor; and
periodically sending the plurality of actuation commands to the plurality of satellite vents with the wireless transmitter at a regular time interval.

5. The method for controlling a heating, ventilating, and air conditioning (HVAC) system on a customized schedule, the method as claimed in claim 4, wherein the regular time interval is once every two seconds.

6. The method for controlling a heating, ventilating, and air conditioning (HVAC) system on a customized schedule, the method as claimed in claim 1 comprises the step of:
providing a wireless receiver, a microprocessor, and a portable power source for each of the plurality of satellite vents;
periodically activating the wireless receiver and the microprocessor with the portable power source at a regular time interval in order to receive the plurality of actuation commands with each of plurality of satellite vents;
continuing to activate the microprocessor with the portable power source for the specific vent in order to reposition the specific vent according the vent position of the specific command,
if a current physical position of the specific vent does not match the vent position of the specific command; and
deactivating the wireless receiver and the microprocessor for the specific vent,
if the current physical position of the specific vent does match the vent position of the specific command.

7. The method for controlling a heating, ventilating, and air conditioning (HVAC) system on a customized schedule, the method as claimed in claim 6, wherein the regular time interval is once every two minutes.

8. The method for controlling a heating, ventilating, and air conditioning (HVAC) system on a customized schedule, the method as claimed in claim 1 comprises the steps of:
providing a louver system, a motor, and a microprocessor for each of the plurality of satellite, wherein the microprocessor is electronically connected to the motor, and wherein the louver system is rotatably driven by the motor;
translating the vent position for the specific command into rotation instructions with the microprocessor; and
executing the rotation instructions with motor in order mechanically reposition the louver system of the specific vent according to the vent position of the specific command.

9. The method for controlling a heating, ventilating, and air conditioning (HVAC) system on a customized schedule, the method as claimed in claim 1 comprises the steps of:
providing an indicator light, a microprocessor, and a portable power source for each of the plurality of satellite vents;
providing a low voltage threshold for the portable power source;
receiving a voltage reading from portable power source with the microprocessor;
illuminating the indicator light with a first color,
if the voltage reading is greater than the low voltage threshold;
illuminating the indicator light with a second color,
if the voltage reading is less than the low voltage threshold; and
deactivating the indicator light,
if the voltage reading is equal to zero.
